(19) United States
(12) Patent Application Publication
(10) Pub. No.: US 2005/0049024 A1
(43) Pub. Date: Mar. 3, 2005

(54) Method of playing a game and a game-playing device

(76) Inventors: Samuel C. Unsicker, Woodridge, IL (US); Terry E. Webb, Aurora, IL (US); Robert Savage, Enfield, CT (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/651,867

(22) Filed: Aug. 29, 2003

(51) Int. Cl. G06F 17/00

(52) U.S. Cl. 463/9

(57) ABSTRACT

A method of playing a game is provided, including selecting a player from a group of players to provide at least one clue as to the identity of an item, selecting a clue type in which the player will provide the at least one clue as to the identity of the item, selecting another player from the group of players to guess the identity of the item based on the at least one clue provided by the player, and repeating the steps of selecting a clue type and selecting another player if the another player does not guess the identity of the item. A game apparatus is also provided, having a controller programmed to perform the method of playing a game.

### BACKGROUND OF THE INVENTION

The present disclosure is directed to a method of playing a game, and in particular to a method of playing a guessing game and a game-playing device used in playing the guessing game.

U.S. Pat. No. 6,279,909 to Alexander II et al. includes illustrations of a board game including a plurality of cards, in which a plurality of teams, each with a plurality of players, compete. Alexander II et al. states that a team to the right of a starting team draws a card from one of the decks and reads the activity section of the card to the starting team. The starting team then attempts to complete the activity set forth in the activity section of the card before time elapses. If the team is successful, the team may roll a die and advance a marker representative of the team along an inner path in accordance with the rolled die. If the team is unsuccessful, the team advances along an outer path. Either way, the starting team's play is over, and a member of the starting team reads a card from one of the decks for the next team. To win, a team must move their marker from the starting position to the end position.

### SUMMARY OF THE INVENTION

According to an aspect of the present invention, a method of playing a game is provided. The method includes selecting a player from a group of players to provide at least one clue as to the identity of an item, selecting a clue type in which the player will provide the at least one clue as to the identity of the item, selecting another player from the group of players to guess the identity of the item based on the at least one clue provided by the player, and repeating the steps of selecting a clue type and selecting another player if the another player does not guess the identity of the item.

According to another aspect of the present invention, another method of playing a group game is provided. The method includes selecting a giving player from a group of players to provide clues as to the identity of a word, selecting a first clue type in which the giving player will provide at least a first clue, the first clue type selected from the group consisting of an oral clue type, a written clue type and an acted clue type, and selecting a first receiving player from the group of players to guess the identity of the word. The method also includes selecting a second clue type in which the giving player will provide at least a second clue if the first receiving player did not guess the identity of the word, the second clue type selected from the group consisting of an oral clue type, a written clue type and an acted clue type, and selecting a second receiving player from the group of players to guess the identity of the word. The method further includes selecting a third clue type in which the giving player will provide at least a third clue if the second receiving player did not guess the identity of the word, the third clue type selected from the group consisting of an oral clue type, a written clue type and an acted clue type; and selecting a third receiving player from the group of players to guess the identity of the word.

According to a further aspect of the present invention, a game apparatus is provided. The game apparatus includes a housing, at least one output device, and a controller disposed in the housing and coupled to the at least one output device, the controller including a processor and memory. The controller is programmed (i) to select a player from a group of players to provide at least one clue as to the identity of an item, (ii) to activate the at least one output device to indicate the player selected, (iii) to select a clue type in which the player will provide the at least one clue as to the identity of the item, (iv) to activate the at least one output device to indicate the clue type selected, (v) to select another player from the group of players to guess the identity of the item based on the at least one clue provided by the player, and (vi) to activate the at least one output device to indicate the another player selected. The controller is also programmed to repeat (iii)-(vi) if the another player does not guess the identity of the item.

The features and advantages of the present invention will be apparent to those of ordinary skill in the art in view of the detailed description of the preferred embodiment, which is made with reference to the drawings, a brief description of which is provided below.

### BRIEF DESCRIPTION OF THE DRAWINGS

FIG. 1 is a perspective view of a game-playing device used in playing a game;

FIG. 2 is a rear view of the game-playing device of FIG. 1;

FIG. 3A is a front view of a card for use with the game-playing device of FIG. 1;

FIG. 3B is a rear view of the card of FIG. 3A;

FIG. 4 is a schematic of electrical components for use with the game-playing device of FIG. 1;

FIG. 5A is a front view of a carrier assembly for use in the game-playing device of FIG. 1 in a first state;

FIG. 5B is a front view of the carrier assembly of FIG. 5A in a second state, with the gear train and motor removed;

FIG. 5C is a front view of the carrier assembly of FIG. 5A in a third state, with the gear train and motor removed

FIG. 5D is a front view of the carrier assembly of FIG. 5A in a fourth state, with the gear train and motor removed

FIG. 5E is a front view of the carrier assembly of FIG. 5A in a fifth state, with the gear train and motor removed

FIG. 6 is a flowchart illustrating a first embodiment of a method of playing a game; and

FIG. 7 is a flowchart illustrating a second embodiment of a method of playing a game.

### DETAILED DESCRIPTION OF A PREFERRED EMBODIMENT

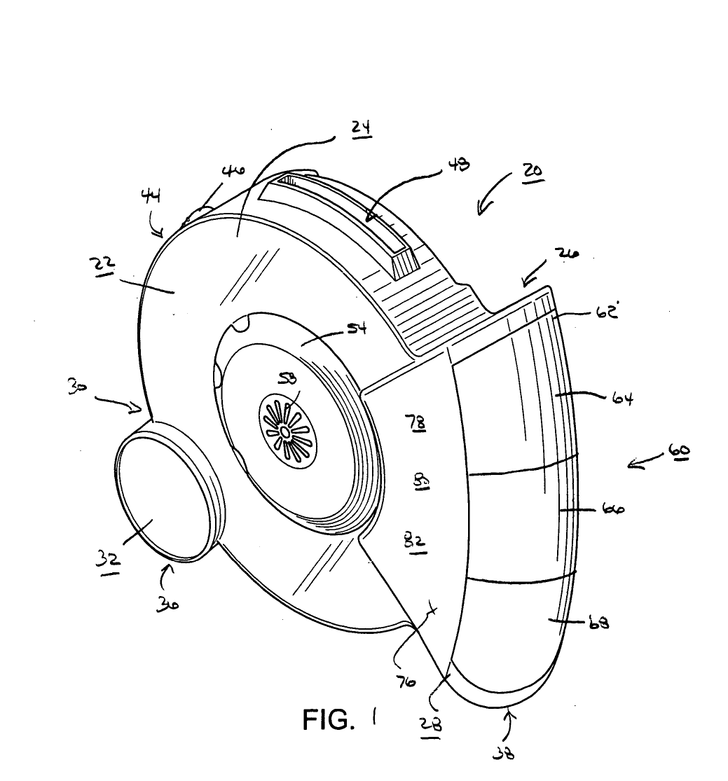

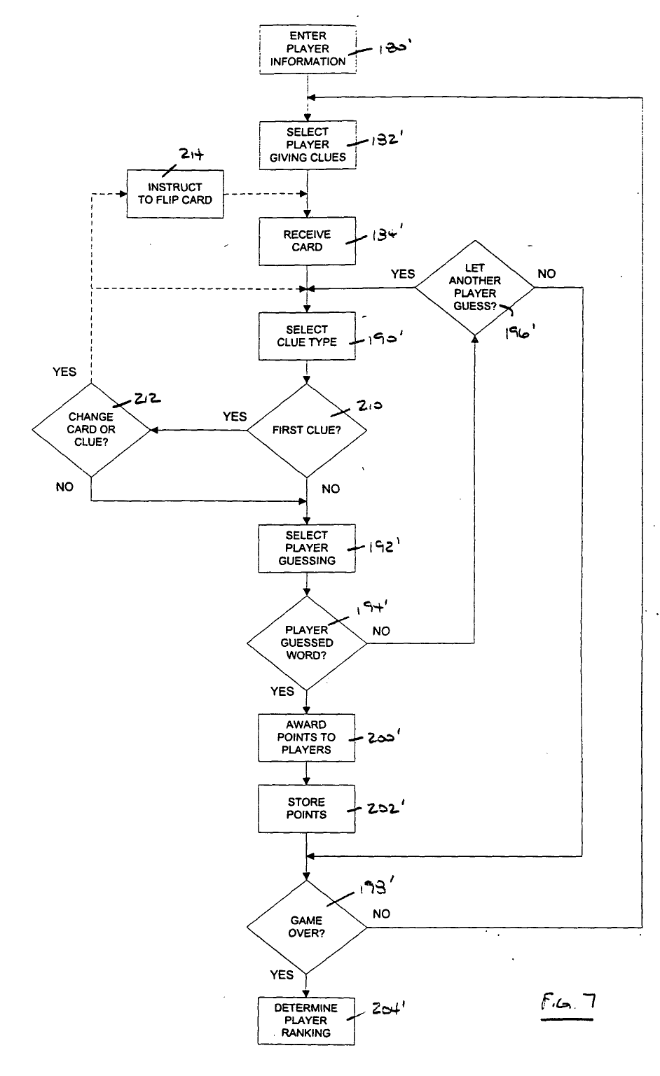

FIG. 1 shows a gaming device 20. The gaming device 20 may be used in playing a game according to the methods of FIGS. 6 and 7, as explained in greater detail below. However, before explaining the gaming method in detail, the structure and operation of the gaming device 20 is first discussed in detail.

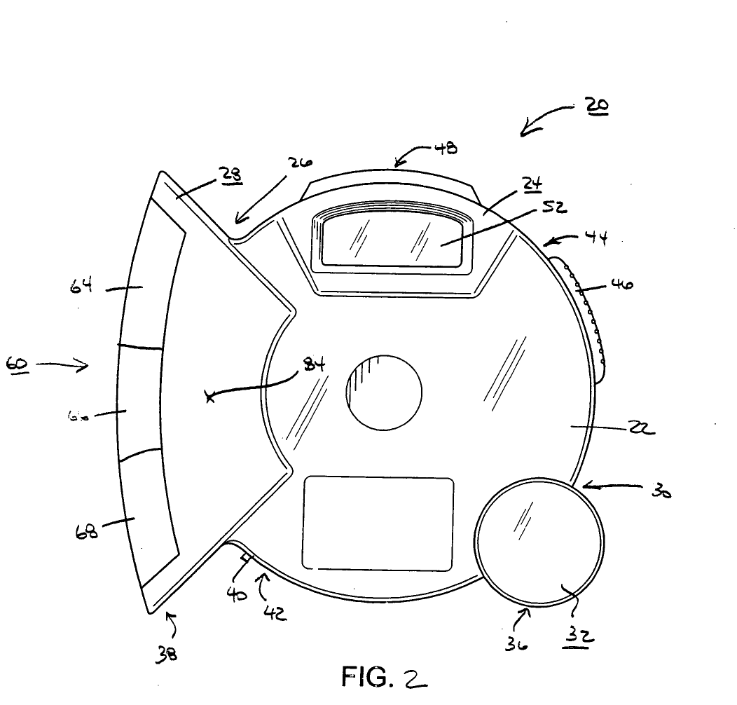

As will be recognized from FIGS. 1 and 2, the gaming device 20 may include a housing 22 which has the appearance of being assembled from a number of cylinders or cylindrical sections. Specifically, a first, or main, cylindrical section 24 is joined at one end 26 to a second cylindrical section 28 and at the other second 30 to a third cylindrical section 32. When the gaming device 20 is disposed on support surface, such as a table top, the surface 36 of the section 32 and the lower edge 38 of the section 28 may abut the table top and hold the gaming device 20 upright. While the remainder of this description will assume that the device 20 is disposed in this orientation, to permit the use of directional terms such as lower, upper, etc., it will be understood that other orientations of the housing 22 may be possible.

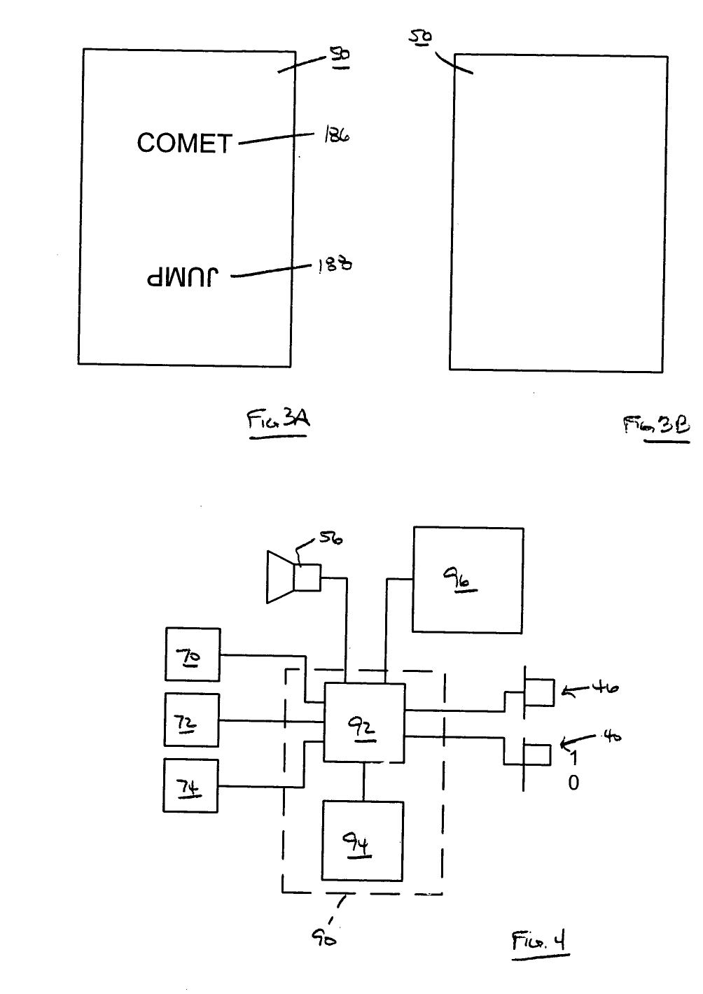

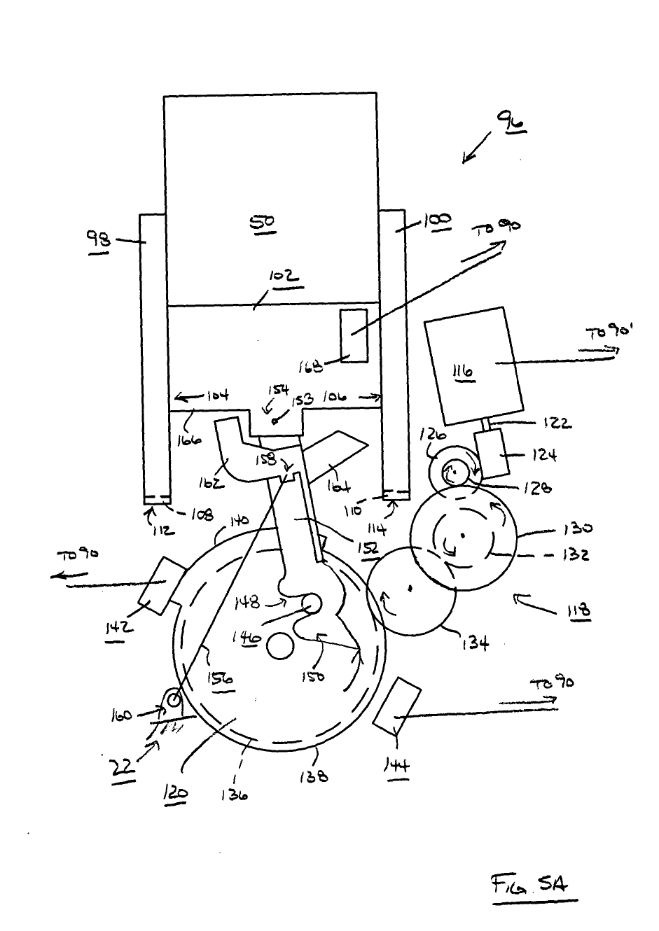

The first cylindrical section 24 has a first switch 40 disposed on a lower surface 42 thereof. The switch 40 may be used to turn the gaming device 20 on or off. On an opposite, upper surface 44 may be disposed a second switch 46. This switch 46 may be used to provide an input to the gaming device 20 when the gaming device 20 has been activated. The first cylindrical section 24 may also have a slot 48 provided therein to receive one or more cards 50, as shown in FIGS. 3A and 3B. The cards 50 may be disposed in the slot 48, and may be viewed, at least in part, through a window 52 that may be provided in a recess in the rear of the section 24. On the front of the section 24 may be a speaker mounting plate 54 behind which a speaker 56 (see FIG. 4) may be mounted, the speaker mounting plate 54 having an aperture 58 formed in the center thereof.

The second cylindrical section 28 may have a light display subsection 60 defined by a translucent wall 62. The region behind the translucent wall 62 may be divided into three separate subregions 64, 66, 68, each of which may have a different one of three lights 70, 72, 74 (see FIG. 4) disposed therein. On a front surface 76 of the section 28 may be, according to the present example, three areas 78, 80, 82 in which words, phrases, symbols and/or icons may be disposed, each area 78, 80, 82 corresponding to one of the three subregions 64, 66, 68 and lights 70, 72, 74. For example, the phrase “Speak!” may be disposed in the area 78, the phrase “Act!” may be disposed in the area 80, and the phrase “Draw!” may be disposed in the area 82, along with an icon representative of each phrase. Moreover, similar markings may also be disposed on a rear surface 84 of the section 24 as well.

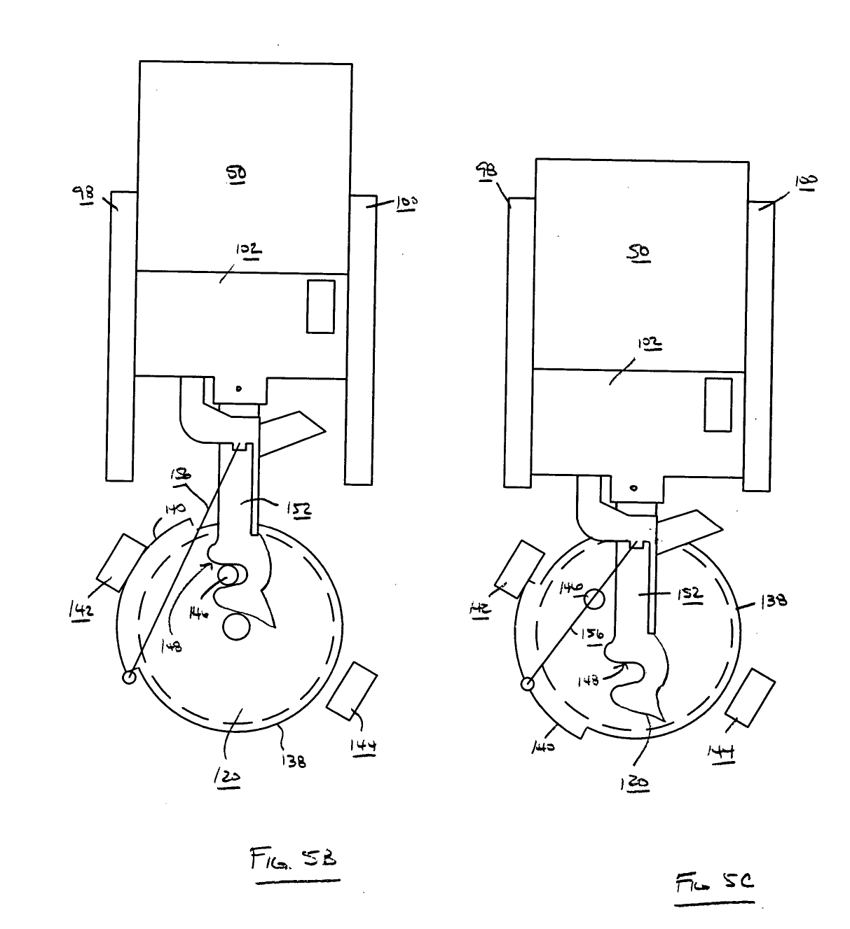

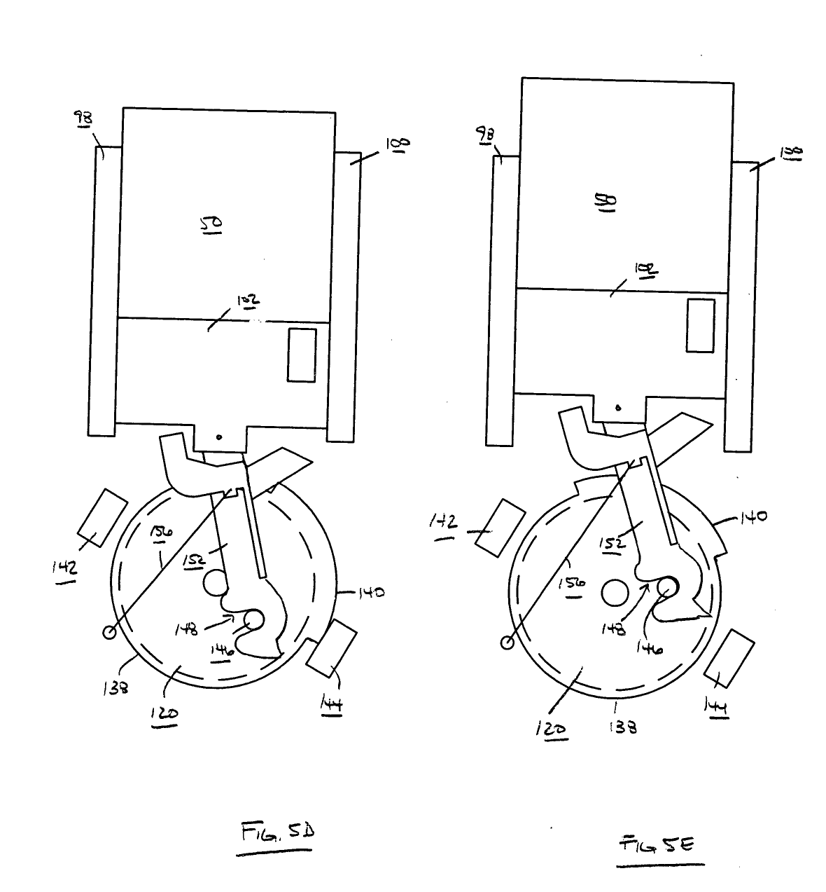

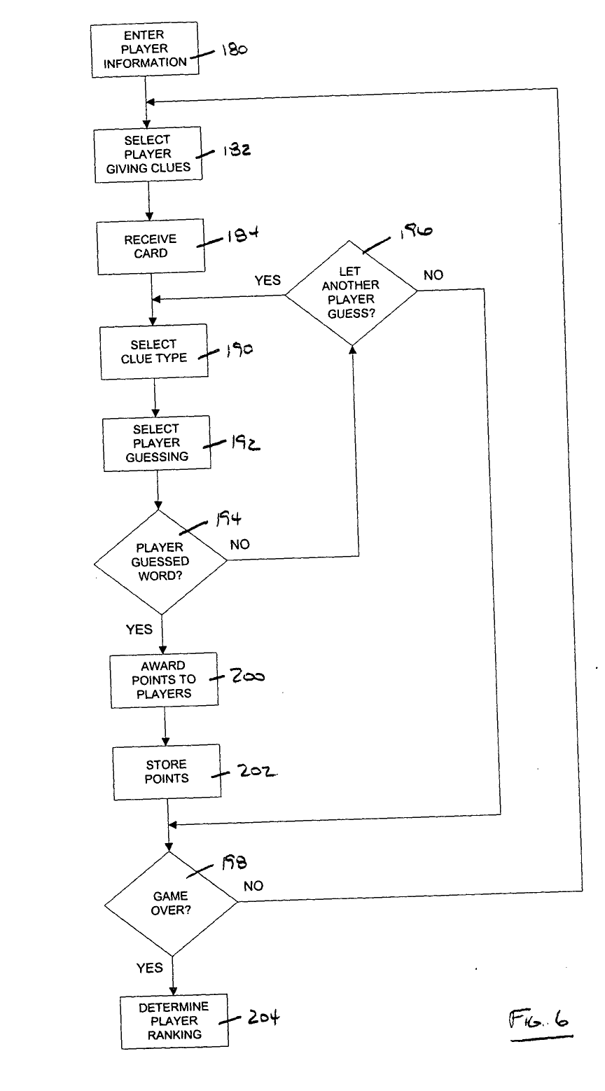

Disposed within the housing 22 may be a number of electrical and electro-mechanical structures, as are illustrated schematically in FIG. 4 and in FIGS. 5A-5E.

Turning first to FIG. 4, the gaming device 20 may include a controller 90, which in turn may include a processor 92 and memory 94. The processor 92 and memory 94 may be a single physical device, or may be physically separate devices that are electrically coupled together. The switches 40, 46 and output devices, such as the speaker 56 and the lights 70, 72, 74, may be coupled to the controller 90. While the switches 40, 46, speaker 56, and lights 70, 72, 74 may be coupled directly to the controller 90, as shown in FIG. 4, an input/output circuit may be interposed between these elements and the controller 90.

Also coupled to controller 90 may be a card carrier assembly 96, which may be explained in greater detail with reference to FIGS. 5A-5E. The carrier assembly 96 may include a pair of channels 98, 100, which channels 98, 100 may be attached to the interior of the housing 22 through the use of fasteners, such as screws, for example. A card carrier 102 may disposed between the channels 98, 100 with ends 104, 106 disposed in the channels 98, 100, the channels 98, 100 guiding the card carrier 102 for translational motion upwardly and downwardly. The channels 98, 100 may have stops 108, 110 at ends 112, 114 to limit the travel of the card carrier 102 in the downward direction.

The carrier assembly 96 may also include a motor 116, a transmission 118 (including a plurality of gears), and a drive wheel 120. The motor 116 may be electrically coupled to the controller 90, such that the motor 116 may be energized and deenergized according to signals received from the controller 90. The motor 116 may have a shaft 122 to which a worm 124 is attached. The worm 124 may mesh with and drive a worm gear 126 that may be formed integrally with and have a common rotational axis with a first gear 128, although it may also be possible that the worm gear 126 and the first gear 128 may be formed separately and then coupled together such that rotation of the worm gear 126 is transmitted to the first gear 128. In turn, the first gear 128 may mesh with and drive a second gear 130, and the second gear. 130 may be formed integrally with or coupled to a third gear 132. The third gear 132 may mesh with and drive a fourth gear 134 that may mesh with and drive a fifth gear 136 formed integrally with or coupled to the drive wheel 120.

The drive wheel 120 may have a first section 138 having a first radius and a second section 140 having a second radius that is larger than the first section 138. First and second sensors 142, 144 may be disposed about the drive wheel 120, be coupled to the controller 90 and cooperate with the second section 140 of the drive wheel 120 as the drive wheel 120 rotates about its axis. As one example, the first and second sensors 142, 144 may be switches that are closed when the second section 140 abuts either the sensor 142 or the sensor 144, and are open when the second section 140 is not abutting the sensors 142, 144. The sensors 142, 144 may be disposed about the drive wheel 120 so that the controller 90 may determine if the drive wheel 120 is at a particular angular orientation or is transitioning between particular angular orientations.

A drive pin 146 may be attached to or formed with the drive wheel 120. As shown in FIG. 5A, the drive pin 146 may be disposed within a recess 148 formed in a first end 150 of a link 152. The link 152 may be attached at a pivot 153 at its second end 154 to the carrier 102, such that the rotational motion of the drive wheel 120, at least in part as explained in greater detail below, causes corresponding translational motion of the carrier 102. The link 152 is biased in a downward direction by a spring 156, which is attached at a first end 158 to the link 152 and at a second end 160 to the housing 22. The link 152 may also have first and second stops 162, 164 formed on opposite sides thereof to limit the motion of the link 152 about the pivot 153 in either rotational direction through cooperation with the surface 166 of the carrier 102.

In operation, when the motor 116 is activated, the motion of the worm 124 may be transmitted to the drive wheel 120 via the transmission 118. In particular, the motion of the worm 124 may cause the motions in the gears 126, 128, 130, 132, 134, 136 as shown in FIG. 5A. Given the coupling of the gear 136 to the drive wheel 120, the wheel 120 may move in the same direction as the gear 136. The angular motion of the wheel 120 may cause the drive pin 146 to move to the left as viewed in FIG. 5A. The motion of the drive pin 146 relative to the link 152 may continue, as shown in FIG. 5B, until such time as the drive pin 146 is no longer disposed within the recess 148. With the pin 146 no longer disposed within the recess 148, the link 152 may move downwardly under the influence of the spring 156, as shown in FIG. 5C. The motor 116 may be deenergized at this point, or at any point prior to the position illustrated in FIG. 5D, to maintain the carrier 102 in a retracted state. If the motor 116 is energized further, the motion of the pin 146, as shown in FIGS. 5D and 5E, may cause the pin 146 to be disposed once more in the recess 148. Cooperation of the pin 146 and the surface of the recess 148 may cause a force to be applied to the carrier 102 via the link 152 counter to the force provided by the spring 156, which counter-force may cause the carrier 102 to be moved upwardly until the cycle repeats.

In the alternative, the carrier assembly may include a carrier, a reversible motor and a transmission that couples the motor to the carrier to cause the carrier to move between a first and a second position. Moreover, the transmission may include a rack and pinion system, the rack being attached to the carrier and the pinion being coupled to the reversible motor. In operation, the motor may be activated such that the shaft moves in a first angular direction, causing the pinion to move in a first angular direction and the carrier to move in a first translational direction (e.g., upwardly). The motor may also be activated such that the shaft moves in a second, opposite angular direction, causing the pinion to move in a second, opposite angular direction and the carrier to move in a second, opposite translational direction (downwardly).

The carrier assembly 96 may also include a sensor 168 attached to or mounted on the carrier 102. The sensor 168 may be coupled to the controller 90, and may provide a signal representative of whether a card 50 is disposed in the carrier 102. The sensor 168 may be, for example, a switch that is open when no card 50 is disposed in the carrier 102 and is closed when a card 50 is disposed in the carrier 102.

In the alternative, the sensor may include a light-emitting element and a light-sensing element coupled to the controller 90. The light-emitting and light-sensing elements may be attached to the carrier in such a manner that a card disposed in the card carrier limits light emitted from the light-emitting element from being detected by the light-sensing element. In this fashion, if the card is removed from the carrier, an increase in the amount of light detected by the light-sensing element will cause the light-sensing element to provide a signal representative of the fact that the card is no longer disposed in the carrier.

Having thus described the gaming device 20 with reference to FIGS. 1-5, the method of playing a game using the gaming device 20 may now be described with reference to FIGS. 6 and 7.

With reference first to FIG. 6, the game method starts at a block 180 with the entry of player information. The type and amount of player information entered into the game device 20 may vary according to the ability of the game device 20 to receive and store the information. According to the present example, the entry of player information may be simplified through the use of colored disks or chips that are distributed to each of the players, each of the players thus being associated or identified with the color of the disk distributed to him or her. The controller 90 may be programmed to announce each color in turn, and to prompt the player to depress the button 46 when he or she hears the color announced that is the color of the chip that was distributed to him or her. For example, the controller 90 may cause the speaker 56 to generate the phrase “If someone picked the red chip, press the button now!” and to sample the input from the button 46 to determine if one of the players has pushed the button 46, indicating that the player has received the red chip. The controller 90 may be programmed to cause the speaker 56 to generate an acknowledgement announcement if the button 46 has been depressed, e.g., “red.”

The controller 90 may then advance through all of the color options, monitoring the button 46 after each announcement, to determine how many players will be playing the game and which colors are associated with the participating players. The controller 90 may also be programmed to cycle back through those options that have not been selected if the number of players indicating their participation in the game is less than a predetermined number, for example, three. Once more than three players have indicated their participation by depressing the button 46 after the color corresponding to their chip has been announced, the method may progress to the next block 182.

At block 182, a player may be selected from the group of participating players to provide at least one clue as to the identity of an item, such as a word, displayed on one of the cards 50. In particular, the controller 90 may be programmed to select one of the participating players to provide clues as to the identity of a word displayed on one of the cards 50. The controller 90 may make this selection randomly, or may select the players according to a predetermined order (for example, the player associated with the color blue always starts, then the player associated with the color red, and so on). The controller 90 may then activate or cause the speaker 56 to announce the color associated with the player that has been selected, perhaps in the form of an announcement such as “Red. It's your turn. Pick a card. Choose the word you want and place the card in the game!” The controller 90 may then monitor the sensor 168 to determine if a card 50 has been placed into the carrier 102. The controller 90 may activate or cause the speaker 56 to provide an aural prompt to the player if a card 50 has not been placed into the carrier 102 within a predetermined amount of time (e.g., “Come on.”; “We're waiting”; or “Ah, hello, anytime today would be nice!”). Once a card 50 is placed in the carrier 102, the method may proceed to block 184.

After the controller 90 receives a signal from the sensor 168 indicative of the fact that a card 50 has been placed into the carrier 102, the controller 90 may activate the motor 116 at the block 184 to cause the carrier 102 to be moved from the state shown in FIG. 5A to that shown in FIG. 5B, thus withdrawing the card 50 into the gaming device 20 such that one of the words on the card 50 is displayed in the window 52. In this regard, it will be recognized that the cards 50, as illustrated in FIGS. 3A and 3B, may have more than one word 186, 188 disposed on a first, or front, side of the card 50 (the second, or rear, side of the card 50 being blank or having a design disposed thereon to prevent the other players from being able to view the words 186, 188 on the front side of the card 50). The words 186, 188 are disposed on the card 50 such that the words 186, 188 are oriented in opposite directions; i.e., one is upside down while the other is right side up. Consequently, when the card 50 is disposed in the gaming device 20 and drawn into the housing 22, only one word will be upright and visible in the window 52.

At a block 190, the controller 90 selects a clue type for the selected player to provide the at least one clue in an attempt to convey the identity of the word 186, 188 on the card 50 to another player. While the controller 90 may actually determine the clue type rather quickly, the controller 90 may be programmed to delay announcing the clue type to provide the impression to the players that the processor 90 is considering the word before providing the clue type. The processor 90 may also be programmed to activate or cause the speaker 56 to generate words or phrases that would be commonly associated with consideration or reflection. For instance, the following phrases might be used: “Hmmm . . . very interesting.” and “Oh, I like this one!”

According to the present example, there are three different clue types (an acted clue type, a oral clue type, and a written clue type), although more than three or less than three clue types may be used according to this method. The acted clue type encompasses that class of clues wherein the player providing the clues (“giving player”) attempts to convey the identity of the word through actions without words, similar to the game of charades. The oral clue type encompasses that class of clues wherein the giving player attempts to convey the identity of the word through oral clues but without accompanying hand or facial gestures. For example, the giving player might say “you go up and down and up and down” n an attempt to convey the identity of the word “jump.” The written clue type encompasses that class of clues wherein the giving player attempts to convey the identity of the word through clues drawn on paper, without words or accompanying hand or facial gestures.

To convey to the player the clue type that he or she is to use to convey the word to another player (“receiving player”), the controller 90 may provide a visual cue by activating the light 70, 72, 74 corresponding to the word, phrase, symbol and/or icon associated with the clue type. Using the phrases introduced above as associated with the lights 70, 72, 74, if a oral clue is to be provided, the controller 90 causes the light 70 to be activated. Alternatively, if an acted clue is to be provided, the controller 90 causes the light 72 to be activated, and so on. The controller 90 may also provide an aural cue to the giving player by activating or causing the speaker 56 to generate an announcement, for example, like “This one is definitely (or certainly) a speak!” for a oral clue. As a further alternative, only a visual or an aural cue may be provided to the giving player.

From the block 190, the method proceeds to block 192. At block 192, the processor 90 may select which player will be the receiving player. The processor 90 may be programmed to select the receiving player randomly from the group of participating players other than the giving player, or the receiving player may be selected according to a particular order (blue, then red, then yellow, etc.). According to the present example, the processor 90 may also be programmed to activate or cause the speaker 56 to provide an announcement to cue the receiving player to the fact that he or she will be guessing. For example, one such announcement may be “Red, you're guessing. Ready? Go!” The controller 90 may also energize the motor 116 to cause the carrier 102 to advance the card 50 out of the device 20 so that the card is accessible, the carrier 102 passing through the states shown in FIGS. 5D and 5E and returning to the state shown in FIG. 5A. The timing of the advancement of the card 50 may occur before the announcement is made, as the announcement is made, or after the announcement is made.

The method then proceeds to a block 194, where the controller 90 determines if the receiving player has guessed the identity of the word 186, 188 on the card 50. There are many different ways that the fact that the receiving player has guessed the identity of the word 186, 188 may be conveyed to the controller 90. For instance, the giving player (or receiving player) may remove the card 50 from the gaming device 20, and specifically the carrier 102, to indicate the fact that the receiving player has guessed the identity of the word 186, 188 on the card 50. The controller 90 becomes aware of the removal of the card 50 from the carrier 102 by a signal from the sensor 168. Alternatively, the giving player (or receiving player) may depress the button 46, and the controller 90 may sample the signal from the button 46 to determine whether or not the receiving player has guessed the identity of the word 186, 188.

The receiving player may be required to guess the identity of the word 186, 188 within a limited period of time. For example, the time limit may be a predetermined number of seconds, e.g. ten. If the receiving player is unable to guess the identity of the word 186, 188 within the time period, the game device 20 may provide a visual and aural cue as to the receiving player's failure to provide an input indicative of the fact that he or she correctly guessed the word prior to the expiration of the time limit. For example, the controller 90 may cause the speaker 56 to generate a noise similar to a buzzer, or an announcement like “Too bad!” or “Oops, not in time!”, or both. The controller 90 may also cause the motor 116 to be energized, causing the carrier 102 to move from state FIG. 5A to the state shown in FIG. 5C. With the carrier 102 in the state shown in FIG. 5C, access to the card 50 may be limited, thereby preventing the giving or receiving players from removing the card 50 from the gaming device 20 once the time period is over.

If the receiving player was unsuccessful in guessing the identity of the word on the card 50 from the clues provided by the giving player, then the method may proceed to block 196, and the controller 90 may determine if another player should be selected to be the receiving player. If it is determined that another receiving player should be selected, the controller 90 may repeat blocks 190, 192, 194 until it is determined at block 196 that no further players should be selected as the receiving player. When number of players permitted to guess the identity of the word 186, 188 is exhausted, the number of iterations thus performed may be described as “completing a turn,” although the “turn” may also be defined as “completed” if one of the receiving players successfully guesses the identity of the word 186, 188, as determined at the block 194.

Each time the method cycles through the block 190, the controller 90 will need to select a clue type in which the clues will be provided to the receiving player. The controller 90 may be programmed to select the clue type according to a variety of different methods. For example, the controller 90 may be programmed to select a clue type at random every time the method passes through block 190. As a variation on this example, the controller 90 may be programmed to permit the giving player to provide clues of the same clue type to consecutive receiving players, or the clue types may be selected such that the same clue type will not be selected for consecutive receiving players. Alternatively, the controller 90 may be programmed to select a different clue type every time the method passes through block 190. For example, the first clue type may be randomly selected to be an acted clue, the second randomly selected to be a oral clue, and the last is selected (because the other two clue types have already been selected) to be a written clue. The controller 90 may be programmed to perform other selection methods as well.

Similarly, each time the method cycles through the block 192, the controller will need to select a player to participate as the receiving player. The controller 90 may be programmed to continue to select receiving players until all of the players other than the giving player have had an opportunity to be the receiving player. Alternatively, the controller 90 may be programmed to select only a predetermined number of players to be the receiving player, e.g., three.

If the controller 90 determines at block 196 that the number of eligible receiving players has been exhausted, then the method proceeds to block 198, and the controller 90 may determine whether the game is over. The controller 90 may make this determination according to a number of methods. For example, the number of giving players to be selected may be limited according to the number of players participating, i.e., each of the players being permitted a turn. Alternatively, the number of giving players to be selected may be limited to a specific number irrespective of the number of players participating in the game. As another alternative, each player may be permitted more than one turn in a game. As a further alternative, the game may be played until the players provide an input to the device that they wish to conclude the game. For example, if a player depresses the button 46 twice, the controller 90 may be programmed to determine that such a signal is associated with the players' desire to conclude the game. If the game is not complete, then the method returns to block 182 and a new giving player is selected.

The block 198 may also be reached if the receiving player is successful at block 194 in guessing the identity of the word on the card 50 from the clues provided by the giving player. If the receiving player is determined to have successfully guessed the identity of the word 186, 188 at block 194, then the method proceeds to block 200, wherein the controller 90 may award points to the receiving player and the giving player. For example, the number of points awarded may be awarded according to a graduated scale, where guessing the identity of the word after the giving player has provided only clues from one clue type is associated with the largest number of points, and guessing the identity of the word after the maximum number of clue types have been used is associated with the smallest number of points. Returning to the example discussed above, wherein a maximum of three players may be selected to be the receiving player before a new player is selected as the giving player, if the first player selected as receiving player guesses the identity of the word based on the clues provided by the giving player, five points are awarded. Alternatively, if the second player selected as receiving player guesses the identity of the word based on the clues provided by the giving player, three points are awarded. If the third receiving player guesses the identity of the word, one point is awarded, and if no players guess the identity of the word, no points are awarded. The controller 90 may be programmed to cause the speaker 56 to generate an announcement corresponding to the points awarded, such as: “Hooray (or Great job, or Well done), you both score five points (or three points, or one point)!” Alternatively, where no points are awarded, an announcement such as “Enough is enough!” or “No points for you!” may be used.

After the points are awarded at block 200, the method proceeds to block 202. At block 202, the controller 90 may store the number of points awarded for both the giving player and the receiving player, thereby permitting a running total to be established and maintained for both players. According to the example provided above, wherein each player is associated with a specific color that is coordinated with the color of the chip that was distributed to them at the beginning of the game, the controller 90 may add the number of points awarded to a number of points stored in a specific memory location associated with the color associated with the player. In this fashion, a points total may be developed for each player for successive iterations of the game wherein different players are giving player and receiving player. The method may then proceed to block 198.

If the controller 90 determines that the game is complete at block 198, the method proceeds to block 204. The controller 90 determines the ranking of the players at block 204 by comparing the points accumulated for each player over the one or more rounds of the game and which of the players has the most points. The controller 90 may be further programmed to cause the speaker 56 to provide an announcement relating the rankings to the players. According to one example, the controller 90 may be programmed to provide an announcement relating (i) the absolute number of points awarded to each player, (ii) their ranking relative to the other players participating, and (iii) the player with the most points (the “winning player”). For example, the announcement might be as follows: “That's it! The game is over! Red, your score is five points. Blue, your score is six points. Yellow, your score is seven points, and that means YOU WIN!”

FIG. 7 shows an alternative method of playing the game using the gaming device 20. Many of the blocks shown in FIG. 7 are similar to those previously discussed above. Similar blocks are numbered similarly, with the similar blocks of FIG. 7 denoted with a prime.

The alternative method in FIG. 7 may start with the player information input at block 180′, and may proceed to block 182′ where the controller 90 selects a giving player. The controller 90 may then determine that a card 50 has been received by the gaming device 20 at block 184′, and may determine a clue type to be used at block 190′. At this point, the alternative method of FIG. 7 may differ from that shown in FIG. 6.

From the block 190′, the method may proceed to block 210, and the controller 90 may make a determination as to whether the clue type provided at block 190′ is the first clue type selected for a given card 50 received by the controller 90 at block 184′. If the present clue type is the first clue type selected, then the method may proceed to block 212, and the controller 90 may determine whether either the clue type or the card 50/word 186, 188 should be changed. If the controller 90 determines that a different card 50, word 186, 188 or clue type is to be used, then the controller 90 may be programmed to provide actions simulative of a “second-guessing” of the card 50/word 186, 188 or clue type. For example, the controller 90 may be programmed to energize the motor 116 to cause the carrier 102 to move from the state in FIG. 5A to that in FIG. 5C. The controller 90 may be further programmed to cause the speaker 56 to provide at the same time an announcement in keeping with the simulated “second-guessing” of the card 50/word 186, 188 or clue type. For example, the announcement may be “Let me see that again!” or the like. It is believed that this simulated “second-guessing” of the card 50/word 186, 188 selected by the player or the clue type selected by the device 20 provides an enhanced perception of spontaneity to the operation of the device 20.

From the block 212, the method may proceed to either to block 214 (if the controller 90 determines that a new card 50/word 186, 188 is to be selected) or to block 190′ (if the controller 90 determines that a new clue type is to be selected). If the method proceeds to block 214, the controller 90 may be programmed to cause the speaker 56 to generate an announcement indicative of the determination that the controller 90 has made that the card 50 or the word 186, 188 is to be changed. Exemplary announcements might include “I think you should do the other word on this card . . . flip it over!” and “Come on, flip it over!” The controller 90 may be programmed to energize the motor 116 at the same time to cause the carrier 102 to move upward, such that the player may access the card 50 and remove it from the carrier 102. The controller 90 may then monitor the signals from the sensor 168 to determine if the card 50 has been replaced into the game device 20. When the card 50 has been replaced, the method may proceed to block 184′, and from there to block 190′.

Provided that the controller 90 makes a determination at block 210 that the clue type selected is not the first clue type, the method proceeds to block 192′, where the controller 90 may select the receiving player from the group of eligible players. From block 192′, the method may proceed to block 194′, and the controller 90 may make the determination as to whether the receiving player has guessed the identity of the word 186, 188. If the receiving player does not guess the identity of the word 186, 188, then the method may proceed to block 196′, where the controller 90 may make a determination if all of the eligible receiving players have been selected. If all of the eligible receiving players have been selected, then the method may proceed to block 198′ and the controller 90 may determine if the game is completed; if less that all of the eligible receiving players have been selected, then the method may cycle back through blocks 190′, 192′, 194′ and 210.

If the receiving player guesses the identity of the word 186, 188, as determined at block 194′, then the method may proceed to blocks 200′, 202′, and the controller 90 awards points to the giving and receiving players and stores the points in such a fashion as they are identified with the giving and receiving players. The method may then pass to block 198′, and if the controller 90 determines that the game is not over, to block 182′. If the controller determines at block 198′ that the game is over, the method may proceed to block 204′, and the player rankings may be announced.

Modifications and alternative embodiments of the invention will be apparent to those skilled in the art in view of the foregoing description. This description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

1. A method of playing a game, comprising:
selecting a player from a group of players to provide at least one clue as to the identity of an item;
selecting a clue type in which the player will provide the at least one clue as to the identity of the item;
selecting another player from the group of players to guess the identity of the item based on the at least one clue provided by the player; and
repeating the steps of selecting a clue type and selecting another player if the another player does not guess the identity of the item.

2. The method according to claim 1, wherein the clue type is one of an oral clue type, a written clue type and an acted clue type.

3. The method according to claim 2, wherein the item is a word.

4. The method according to claim 1, comprising:
repeating the steps of selecting a clue type and selecting another player up to a maximum number of iterations if the another player does not guess the identity of the item.

5. The method according to claim 4, comprising:
repeating the step of selecting a player after the maximum number of iterations is performed or after the another player guesses the identity of the item.

6. The method according to claim 1, comprising:
awarding a number of points to the player and the another player if the another player guesses the identity of the item; and
adding the number of points awarded to the player and the another player to a first running total for the player and a second running total for the another player.

7. The method according to claim 6, comprising:
comparing the first running total and the second running total to determine if the player or the another player has the most points;
declaring a winning player according to which player has the most points.

8. The method according to claim 1, comprising:
changing the clue type in which the player will provide the at least one clue as to the identity of the item to the another player prior to selecting the another player.

9. A method of playing a group game comprising:
selecting a giving player from a group of players to provide clues as to the identity of a word;
selecting a first clue type in which the giving player will provide at least one first clue, the first clue type selected from the group consisting of an oral clue type, a written clue type and an acted clue type;
selecting a first receiving player from the group of players to guess the identity of the word;
selecting a second clue type in which the giving player will provide at least one second clue if the first receiving player did not guess the identity of the word, the second clue type selected from the group consisting of an oral clue type, a written clue type and an acted clue type;
selecting a second receiving player from the group of players to guess the identity of the word;
selecting a third clue type in which the giving player will provide at least one third clue if the second receiving player did not guess the identity of the word, the third clue type selected from the group consisting of an oral clue type, a written clue type and an acted clue type; and
selecting a third receiving player from the group of players to guess the identity of the word.

10. The method according to claim 9, comprising:
determining if the first receiving player guessed the identify of the word; and
awarding a first number of points to the giving player and the first receiving player if the first receiving player guessed the identity of the word.

11. The method according to claim 10, comprising:
determining if the second receiving player guessed the identify of the word; and
awarding a second number of points to the giving player and the second receiving player if the second receiving player guessed the identity of the word, the second number of points being less than the first number of points.

12. The method according to claim 11, comprising:
determining if the third receiving player guessed the identify of the word; and
awarding a third number of points to the giving player and the third receiving player if the third receiving player guessed the identity of the word, the third number of points being less than the second number of points.

13. The method according to claim 12, comprising:
storing a number of points awarded to at least one of the giving player and the first, second, and third receiving players to a individual running total for the at least one of the giving player and the first, second, and third receiving players; and
determining a winning player according to the individual running totals for the giving player and the first, second, and third receiving players.

14. The method according to claim 9, comprising:
repeating the step of selecting a giving player from a group of players to provide clues as to the identity of another word if one or none of the first, second, or third other players guesses the identity of the word.

15. The method according to claim 9, wherein the first, second, and third clue types are different.

16. The method according to claim 9, wherein at least one of the first, second and third clue types is the same as another of the first, second, and third clue types.

17. The method according to claim 9, comprising:
changing the first clue type in which the giving player will provide at least one first clue, the first clue type selected from the group consisting of an oral clue type, a written clue type and an acted clue type, prior to selecting the first receiving player.

18. The method according to claim 9, comprising:
changing the word to another word before the giving player provides the at least one first clue to the first receiving player.

19. A game apparatus comprising:
a housing;
at least one output device; and
a controller disposed in the housing and coupled to the at least one output device, the controller including a processor and memory,
the controller being programmed:
(i) to select a player from a group of players to provide at least one clue as to the identity of an item,
(ii) to activate the at least one output device to indicate the player selected,
(iii) to select a clue type in which the player will provide the at least one clue as to the identity of the item,
(iv) to activate the at least one output device to indicate the clue type selected,
(v) to select another player from the group of players to guess the identity of the item based on the at least one clue provided by the player,
(vi) to activate the at least one output device to indicate the another player selected, and
the controller being programmed to repeat (iii)-(vi) if the another player does not guess the identity of the item.

20. The apparatus according to claim 19, wherein the item is a word and the clue type is one of an oral clue type, a written clue type and an acted clue type.

21. The apparatus according to claim 19, wherein:
the controller is programmed to repeat (iii)-(vi) up to a maximum number of iterations if the another player does not guess the identity of the item; and
the controller is programmed to repeat (i) and (ii) after the maximum number of iterations is performed or after the another player guesses the identity of the item.

22. The apparatus according to claim 19, comprising:
awarding a number of points to the player and the another player if the another player guesses the identity of the word,
adding the number of points awarded to the player and the another player to a first running total for the player and a second running total for the another player,
comparing the first running total and the second running total to determine if the player or the another player has the most points, and declaring a winning player according to which player has the most points.

23. The apparatus according to claim 19, wherein:
the at least one output device comprises a speaker and an array of lights, and
the controller is programmed to cause the speaker to generate an announcement to identify the player selected,
the controller is programmed to activate one of the array of lights to indicate the clue type selected, and
the controller is programmed to cause the speaker to generate an announcement to identify the another player selected.

24. The apparatus according to claim 19, comprising:
a card carrier assembly having a card carrier moveable between a first state in which a card disposed in the card carrier is accessible and a second state in which access to a card disposed in the card carrier is limited.

25. The apparatus according to claim 24, wherein the card carrier assembly comprises:
a pair of channels;
the card carrier disposed between the channels and translatable along the channels between a first position associated with the first state and a second position associated with the second state;
a motor; and
a transmission coupled to the motor and the card carrier to cause the card carrier to translate along the channels.

26. The apparatus according to claim 25, wherein the card carrier assembly comprises:
a wheel coupled to the transmission;
a drive pin attached to the wheel;
a link having a first end attached to the card carrier and a second end with a recess formed therein, the drive pin disposed within the recess when the drive pin is in a first position and the drive pin not disposed within the recess when the drive pin is in a second position; and
a spring having a first end attached to the link and a second end attached to the housing to bias the card carrier toward the second position.

27. The apparatus according to claim 26, wherein the card carrier assembly comprises:
first and second switches coupled to the controller,
the wheel having a first section of a first radius and a second section of a second radius, the second radius being larger than the first radius,
the first and second switches being disposed radially outward of the first radius but at the second radius to permit the second section of the wheel to intermittently contact the first and second switches.

28. The apparatus according to claim 24, wherein the card carrier assembly comprises:
a card carrier in which a card may be received; and
a switch attached to the card carrier and coupled to the controller to provide to the controller a signal representative of whether a card is disposed in the card carrier,
the controller programmed to determine whether the another player has guessed the identity of the item according to whether the card is disposed in the carrier.
